(19) United States
(12) Patent Application Publication
(10) Pub. No.: US 2013/0032519 A1
(43) Pub. Date: Feb. 7, 2013

(54) Biological sewage treatment device

(71) Applicant: Bogdan Murawski, Glen Cove, NY (US)

(72) Inventor: Bogdan Murawski, Glen Cove, NY (US)

(21) Appl. No.: 13/136,492

(22) Filed: Aug. 2, 2011

(51) Int. Cl. C02F 3/30; C02F 3/22

(52) U.S. Cl. 210/195.3

(57) ABSTRACT

This invention is a biological sewage treatment device and system for use as a facility for the collection and purification of sewage from small and mid-sized buildings such as single-and multi-family homes, hotels, motels serving from 4 to 200 people. The invention provides for an automatically-regulating treatment process, based on low-load active sediment technology with extended oxygenation time, utilizing filtration on a suspended active sediment.

The biological sewage treatment device system for use as a facility for the collection and purification of sewage invention relates to improvements in an aerobic sewage treatment system, and the type of system shown in the inventor's prior U.S. Pat. No. 4,620,925 issued 4 Nov. 1986. The biological sewage treatment device concerned by this invention is composed of two cylindrical tanks, or of one polygonal tank and containing an anaerobic, an aerobic, sedimentation and filtering chambers, as well as recirculation tubes, so that the first tank is divided by two oblique walls that join seamlessly to its bottom and casing into three separate sections.

The largest of the sections, widens from two sides toward the bottom, where it contains an air diffuser and forms an aerobic chamber. The other smaller section of the tank forms an anaerobic chamber. The third tank section is a separate sedimentation chamber. On one side of the tank's anaerobic chamber, in the tank casing there is a sewage inlet, in the sedimentation chamber in the tank casing, there is a outlet to the second cylindrical tank, while on the other side of the sedimentation chamber, in the mid section, there is a flow opening above the sedimentation chamber bottom, which opening is surrounded by the guide sleeve wall from the direction of the aeration chamber. Furthermore, the tank has two recirculation tubes. The inlet of the first recirculation tube is near the aerobic chamber bottom, while its outlet is in the anaerobic chamber above the sewage level. The inlet of the other tube is at the bottom of the sedimentation chamber, while the recirculation tube outlet is in the aerobic chamber above the sewage level. It's better when the clean water outlet in first tank is located below the sewage inlet. It's also better when the wall of the sedimentation chamber from the direction of the water outlet is vertical, and the other wall opposite to is runs obliquely, reducing the cross-section of said chamber in the direction of its bottom. It's best when the wall of the sedimentation chamber is inclined at the angle 20-40 degrees. It's best when the air diffuser is tubular and located between the oblique walls at an equal distance from them and parallel to them. The device is best constructed when an air distributor is fastened to the upper section of the tank, the distributor having six or more separate outlet tubes, of which one at the bottom of anaerobic chamber, while the remaining tubes are respectively attached to the air diffuser and the two recirculation tubes. One outlet tube is attached to bottom of pumping chamber in second tank. The best aeration is achieved when the oblique walls are inclined at an angle of 20-40 degrees. The outlets of all the recirculation tubes are located above the tank's maximum fill level. Clean water flows out via gravity from the first tank in to other one. The clean water outlet is located at the end of the tank. An advantage of this invention's design is its high performance, it meets all the requirements and quality parameters for the treatment process, while also being simple to construct and inexpensive to operate. This is especially evident at sewage volumes from 1 to 50 cubic meters of sewage per day

The invention is illustrated in the drawings:

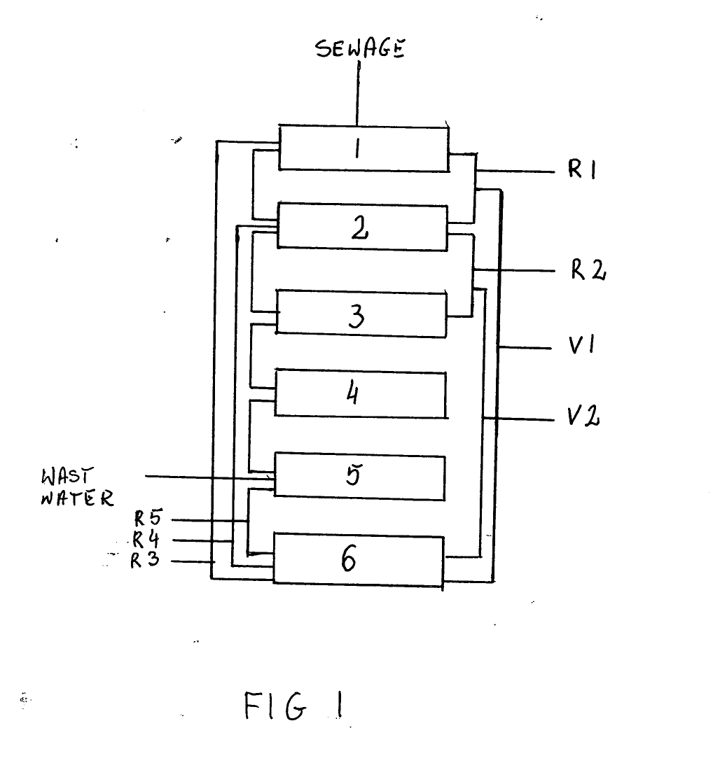

FIG. 1 showing a diagram of the biological waste treatment system, and

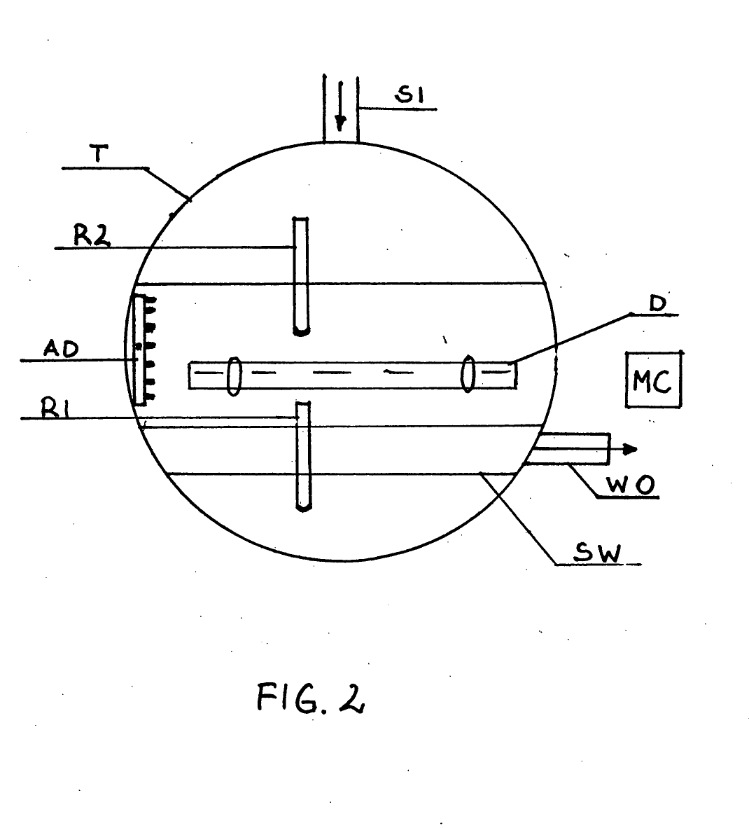

FIG. 2 depicting a view from above of the biological waste treatment device of tank one;

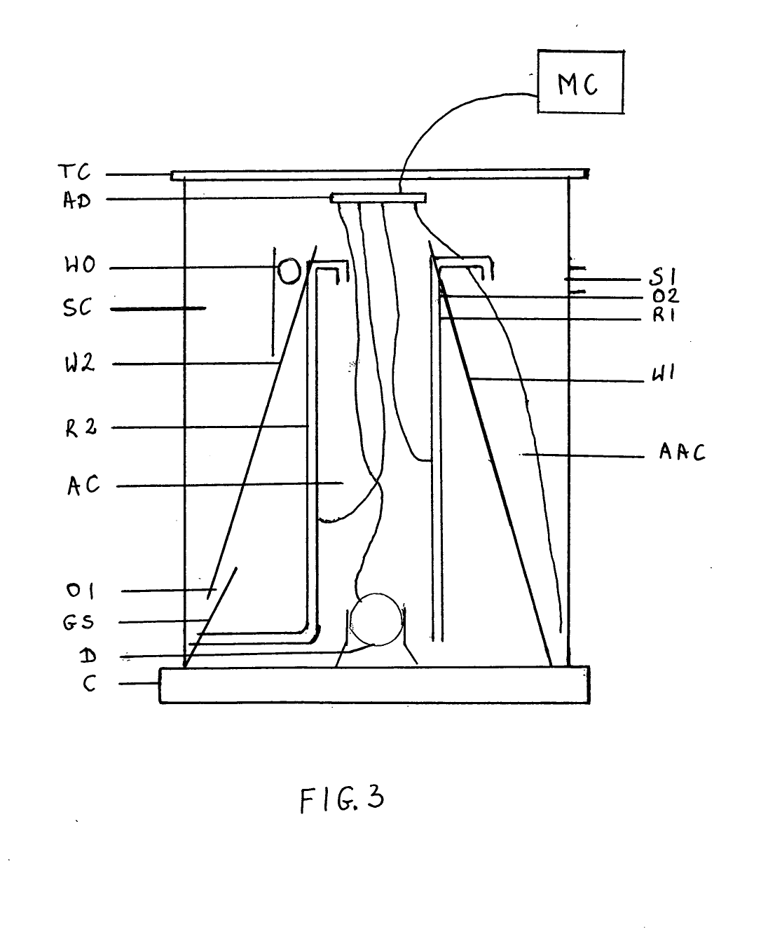

FIG. 3 is a view of the device in cross-section.

This model biological sewage treatment system inputs sewage into the anaerobic activation are (1), whose upper section is connected to the upper part of the aerobic activation area (2), which in turn is connected to the lower section of the sedimentation area (3). Sedimentation area is connected in upper part with filtration area (4). Filtration

section is connected to the lower section of the pump area (5). The efflux of water from area 5 is the system output. The system also contains two recirculation junction (r1, r2). The former (r1) is located between the lower section of the aerobic activation area (2), and the upper section of the anaerobic area (1). The separate second recirculation junction (r2) is located between the lower section of the sedimentation area (3) and the upper section of the aerobic activation area. In this system recirculation junctions are connected separately via valves (v1, v2) with a common air source (6).

The name air source (6) uses separate values (v3, v4, v5) to connect respectively to the anaerobic activation area (1), the aerobic activation area (2) and the pump area (5). The air distributor and compressor are the air source (6). The system utilizes gravity flow from the input to the pump chamber, via the successive areas (1, 2, 3, 4), while using regulated air jets for mixing in the anaerobic activation area (1) and the aerobic activation area (2). Air is supplied in great quantities to the aerobic activation chamber (2) and causes the respective biological and chemical reaction to occur there. The system also uses air to induce recirculation flows that cause some of the substance from the sedimentation area (3) to move to the aerobic activation area (2), from which in turn some of its contents move to the anaerobic area. The model biological sewage treatment device has two tanks. One of them, tank (T), is cylindrical or polygonal, made of polyethylene or fiberglass, is set on concrete foundation (C). Tank (T) is divide into three various-size chambers by two oblique walls, each inclined between 15-25 degrees from the vertical, and joined seamlessly to the tank (T) bottom. Said walls are located parallel to each other on opposite sides of the tank, and they narrow downwards toward the bottom of the tank (T), toward the outer walls, thus forming between them the largest chamber, which widens toward the bottom on both sides both sides. That section constitutes the aerobic chamber (AC). The second smaller section of the tank forms the anaerobic chamber (AAC), with the third section of the tank forming the sedimentation chamber (SC), in tank (T) on one side of the anaerobic chamber (AAC) is the round sewage inlet (SI). The tank casing houses the sedimentation chamber (SC) with the round water outlet (WO) located somewhat lower than the sewage inlet (SI). The oblique wall dividing the aerobic chamber (AC) from the sedimentation chamber (SC) has one flow opening (O1), located within the sedimentation chamber a guide sleeve (GS) on said opening. The other oblique wall dividing aerobic chamber (AC) form the anaerobic activation chamber (AAC) at the level of the upper maximum tank fill level, houses the round flow opening (O2). In the aerobic chamber, (AC) the tubulen air diffuser (D) is fastened to the tank bottom; said diffuser is located between the two oblique walls (W1, W2), parallel to them, at a distance of 5 to 10 inches from the bottom. One recreation tube (R2) passes through wall (W2), the tube's inlet is located above the bottom of the sedimentation chamber (SC), and the tube passes under the flow opening (O1), which has a diameter larger than the tube, and also passes under the quiole sleeve (GS), with the tube outlet located in the upper section of the aerobic chamber (AC). The input of the other recirculation tube (R1) is located below the bottom of the aerobic chamber and the tube's outlet is in the anaerobic chamber (AAC), above the partition with the openings (OO). The tube (R1, R2) passage through the walls is leak-tight. The air distributor (AD) is fastened to the upper section of the box next to the tank, or on the tank cover (TC). The distributor has at least six separate outlet tubes equipped with valves. One of them has an outlet over the bottom of the anaerobic chamber (AAC), while the second has an outlet pumping chamber, in second tank. The other distributor outlet tubes are respectively connected to the air diffuser (D) and to each of the two recirculation tubes (R1, R2) The second tank is cylindrical in shape and is hermetically divided by a vertical wall into two chambers. The first chamber is a filtration chamber, into which the purified water flows via gravitation from the first chamber, as does water from the washing machine and dishwasher. The water flowing form the permanent components is purified in that chamber. In the vertical wall dividing the tank at 25 to 30 inches form the bottom, there is a flow aperture through which water from the filtration chamber flows to the pumping chamber. At the bottom of the second chamber, a water pump is installed, which pumps purified water to either the sprinkler system or the soak way. There is also an air tube installed near the bottom of that chamber. When the biological sewage treatment device is polygonal in shape, there is no need to install the second tank, because the objective is achieved by increasing the size of the polygonal tank by two chamber, a filtration chamber and a pumping chamber. In such case, the treatment process takes place in one tank, divided (separated) into five chambers: an anaerobic, aerobic, sedimentation, filtration and pumping chamber. raw sewage is input to the anaerobic chamber area through the sewage inlet (SI). That chamber mixes the raw sewage with the active sewage with the active sewage, and sewage undergoes preliminary decomposition and denitrification under anaerobic conditions. The mixing and flow in that section of the tank is aided by a weak air jet from the outlet of the second air distributor (AD). The influx of active sewage needed for the denitrification process takes place via the first recirculation tube (R1), which handless the flow of active sediment forced by the mammoth pump from the bottom of the aerobic chamber (AC) anaerobic chamber (AAC). From the anaerobic chamber (AAC), the active mix passes through the second outlet opening (O2) in the oblique wall (W1) to the aerobic chamber (AC). The sewage is intensively oxygenated in that chamber via aeration from the tubular air diffuser (D) located at the chamber bottom. From that section of the tank, the active mix passes through the flow opening (O1) into the lower section of the sedimentation chamber (SC). The mix passes through said opening, being in constant motion in the aerobic activation chamber, aided by the guide sleeve (GS). The mix settle in the sedimentation chamber, where the reaction rate slows, although the fluid filtration deposit made up of the suspended active sediment is maintained. The sedimentation process occurs in sais chamber, i.e., the active sediment is separated and falls to the bottom, while the clean water rises upward and flows out through the water outlet (WO) in the tank (T) casing and flows into tank two (T2) to filtering chamber than throw opening in dividing wall to pumping chamber.

The processes in this biological sewage processing device are cyclical, repeating themselves with every influx of new raw sewage, which causes the fluid level to rise in the two tanks and the flow between the anaerobic activation chamber, the aerobic activation chamber, the sedimentation chamber and filtering chamber with the efflux of clean water from tank two and the equalization of the level in the two tanks. The device as described provides long-term activation, thorough stabilization of the sediment, in consequence of which the sewage treatment is 94 to 96% effective. The output water yielded can be fed to reservoirs such as ponds or rivers, or may be used to water plants, grass, etc. The waste sediment yielded in the treatment process is biologically air-stabilized and undergoes no further biological decomposition. The excess sediment is pumped out of the tank. The model dimensions and parameters of tank one are as follows: for EM load (equivalent number of inhabitants)=4 to 5 and daily flow of 1.2 to 1.6 cubic meters/day, the tank is 1.55 meters high, diameter of 1.52 meter, weight of 180 kilograms, and installed power output is 80 W. Tank size and number of diffusers increase depending on the amount of inflowing sewage. The invention provides for an automatically-regulating treatment process, based on low-load active sediment technology with extend oxygenation time, utilizing filtration on a suspended active sediment, as well as utilizing plants to reduce nitrogen and phosphorus compounds, also utilizing a biological bed.

1. A biological sewage processing device consisting of direct flow through consecutively inter connected areas for anaerobic activation, aerobic activation, sedimentation and filtration, equipped with a forced recirculation system beginning at the sewage inlet leading to the anaerobic chamber and ending at the water outlet from the filtration chamber, wherein the aerobic activation are is connected to an air source. Whereas the connection between the anaerobic activation are (1) and the aerobic activation are (2) is in the upper section of the said areas, and the two independent recirculation connections (R1, R2) connect, respectively, the lower section of the aerobic activation area (2) to the anaerobic chamber (1), and the lower section of the sedimentation area (3) to the aerobic activation area (2).

2. Where as each recirculation connection (R1, R2) and the anaerobic activation area (1), the aerobic activation area (2) and the pumping chamber (5) are connected via separate valves with a common air source (6).

3. Whereas the biological sewage processing device is equipped with an anaerobic chamber and an aerobic chamber with an air diffuser, sedimentation and filtration chamber as well as two recirculation tubes. The sewage inlet (SI) is located over the anaerobic chamber (AAC) and above the sewage level, while the outlet (WO) from the first tank (T1) is located in the sedimentation chamber (SC), and the inlet in the second tank is in the filtration chamber, which is connected to the pumping chamber (PC) in the lower section of the wall dividing the tank (T2) in to two areas. The tank (T1) has two recirculation tubes (R1,R2) with the inlet of the first of them (R1) being located over the bottom of the aerobic chamber, while the outlet is located in the anaerobic chamber (AAC) above the sewage level. The inlet of the second recirculation is located over the bottom of the sedimentation chamber (SC), while the outlet is in the aerobic activation chamber (AC) above the sewage level. Aeration lines are installed at the bottom if the anaerobic chamber and the pump chamber.

4. The device in claim 3, whereas the outlet of the filtration chamber is located in the lower section of the wall dividing the filtration chamber and the pump chamber.

5. The device in claim 3, whereas the air diffuser (D) is tube-shaped and located between the two oblique walls parallel to them.

6. Whereas the walls (W1, W2) are inclined at a 20- to 40-degree angle.
